(19) United States
(12) Patent Application Publication
(10) Pub. No.: US 2022/0383297 A1
(43) Pub. Date: Dec. 1, 2022

(54) SYSTEMS AND METHODS ASSOCIATED WITH NETWORK-BASED INTERACTIONS

(71) Applicant: MASTERCARD INTERNATIONAL INCORPORATED, Purchase, NY (US)

(72) Inventors: Akshat Gupta, Glastonbury, CT (US); Iain Shand, Broxbourne (GB)

(21) Appl. No.: 17/331,199

(22) Filed: May 26, 2021

(51) Int. Cl. G06Q 20/36; G06Q 20/22; G06Q 20/40; G06Q 20/34

(52) U.S. Cl. CPC G06Q 20/3674; G06Q 20/227; G06Q 20/4014; G06Q 20/351; G06Q 20/3552

(57) ABSTRACT

Systems and methods are provided for altering images associated with accounts, for use with digital wallets. One example computer-method includes receiving a request for an image associated with an account, informing an issuer of the account of the request, and receiving, from the issuer, an image and a base configuration ID for the account. The method also includes retrieving a base configuration profile for the account, creating a new configuration profile for the account, and returning, to the issuer, a new configuration ID for the new configuration profile. The method further includes receiving, from the issuer, in response to the new configuration ID, a token for the account, linking the token to the new configuration profile based on the new configuration ID, and pushing the image to an electronic device associated with the account thereby permitting the electronic device to display the image when the account is selected.

### FIELD

The present disclosure generally relates to systems and methods associated with network-based interactions, and more particularly, to systems and methods for use in altering network-based interfaces that are associated with user accounts and that are used to perform actions relating to the accounts.

### BACKGROUND

This section provides background information related to the present disclosure which is not necessarily prior art.

User accounts are known to be associated with physical objects (e.g., plastic cards, fobs, etc.) and digital objects (e.g., tokens, etc.), whereby the accounts may be identified to third parties by way of the physical and/or digital objects. For example, a payment account may be presented, via a digital wallet, as a token associated with the account. The digital token may be presented at a third party, whereby an interface representative of the account is displayed to the user and the third party. In such an example, the interface may include a digital representation of a card for the account at a mobile device of the user and/or third party (e.g., a smartphone, a wearable device, etc.). The digital representation of the card, for example, is defined by an issuer of the account, and often includes a logo associated with the issuer and/or a logo associated with the network responsible for processing account transactions associated therewith (e.g., Mastercard, Visa, AMEX, etc.).

### DRAWINGS

The drawings described herein are for illustrative purposes only of selected embodiments and not all possible implementations, and are not intended to limit the scope of the present disclosure.

FIG. 1 illustrates an example system of the present disclosure suitable for use in modifying card images of digital cards for accounts presented in and/or included in digital wallets;

FIG. 2 is a block diagram of a computing device that may be used in the example system of FIG. 1;

FIG. 3 is an example method, which may be implemented in connection with the system of FIG. 1, for appending an image to an image of a digital card associated with an account;

FIGS. 4A-4B illustrate an example application of the method of FIG. 3 to append an image to an image of a digital card, where FIG. 4A includes a base card image for the digital card and FIG. 4B includes the base card image with a badge included therein;

FIG. 5 is another example method, which may be implemented in connection with the system of FIG. 1, for altering a card image of a digital card associated with an account to include an added image; and

FIGS. 6A-6B illustrate an example application of the method of FIG. 5 to alter an image of a digital card, where FIG. 6A includes a base card image for the digital card and FIG. 6B includes the base card image with a dynamic image included therein.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Typically, when a digital card (e.g., as representative of a credit card, a debit card, a prepaid card, other cards, etc.) associated with an account is presented for payment during a transaction, via a digital wallet, at a third party, an image of the digital card is displayed or presented at an electronic device (e.g., a smartphone device, a wearable device, etc.), where the image includes a logo associated with a payment network for processing the transaction and, potentially, a name of a user presenting the digital card. In connection therewith, the image of the digital card is generally limited to an image managed by an issuer of the account. As such, the image may be generic for multiple various accounts, regardless of specific user and/or account as well as, for example, donation activities associated with the user.

Uniquely, the systems and methods herein permit dynamic images to be associated with user accounts, whereby the dynamic images are presented at or through digital cards (e.g., as part of digital wallets or otherwise, etc.), for example, when the digital cards are viewable and/or used in transactions, etc. For instance, the systems and methods herein may allow for updating, modifying, etc. an image of a digital card, associated with an account, to include additional details, data, images, etc. particular to the user and/or the account associated therewith. In doing so, the system and methods herein may allow for tailoring the image of the digital card to the user and/or the user's account.

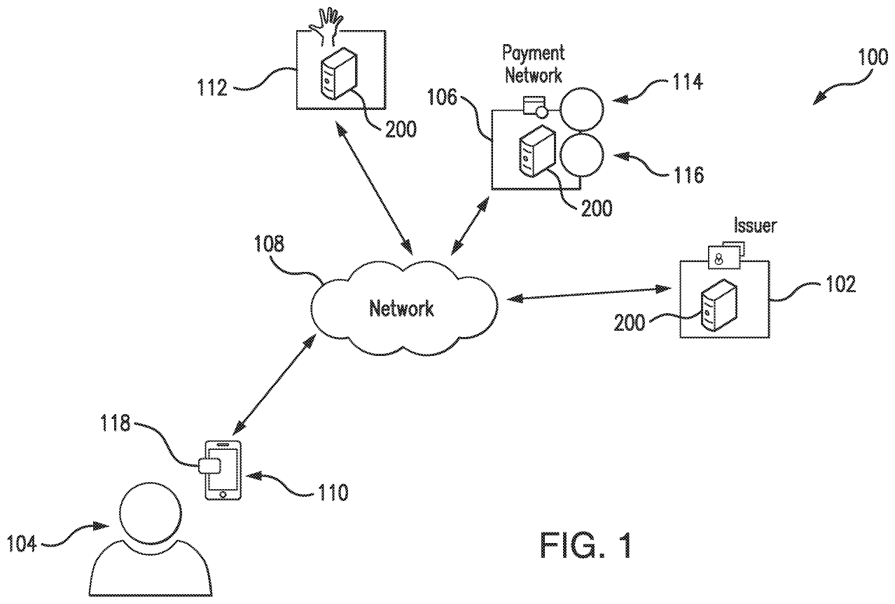

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, implementation of one or more contribution platforms, one or more payment networks involved in the system, one or more account issuers involved in the system, etc., coordination of account transactions, registration and/or onboarding procedures, privacy rules and/or regulations, etc.

The system 100 generally includes an issuer 102, which issues user accounts to users (e.g., to user 104, etc.), and a payment network 106. Each of the issuer 102 and the payment network 106 is coupled to, and is in communication with (and/or includes access to), network 108. The network 108 may include, without limitation, a local area network (LAN), a wide area network (WAN) (e.g., the Internet, etc.), a mobile network, a virtual network, and/or another suitable public and/or private network capable of supporting communication among two or more of the parts or users illustrated in FIG. 1, or any combination thereof. For example, network 108 may include multiple different networks, such as a private payment transaction network made accessible by the payment network 106 to the issuer 102, to facilitate network-based interactions therebetween and, separately, a public network (e.g., the Internet, etc.) through which a user (e.g., the user 104, via communication device 110; etc.) interacts with the issuer 102, a contribution platform 112, etc.

The issuer 102, as described above, issues payment accounts to users, and associated funds, credit, etc. to the accounts for use by the users to fund transactions, etc. The issuer 102, in general, may include a bank or other financial institution, etc.

In the illustrated embodiment, the system 100 also includes contribution platform 112 coupled to, and in communication with, the network 108. The contribution platform 112 is configured to receive donations (broadly, contributions) from users. It should be appreciated, though, that the contribution platform 112 is not required in all embodiments, and is shown in the system 100 so that the same system 100 may be used in connection with the descriptions hereinafter of both method 300 and method 500. That said, when included, the contribution platform 112 may include any charity or other institution to which users donate funds for reasons related to charity, affiliation, support, etc. of the organization responsible for the contribution platform 112. The organization may be associated with, for example, researching cures for diseases (e.g., cancer, etc.), supporting persons displaced by disasters, religious groups, educational groups, or even political groups, etc. More generally, the organization may include any business, institution, entity or person that the user 104, for example, may wish to contribute funds. In connection therewith, the contribution platform 112 is configured to facilitate network transactions for the funds, whereby the funds are transferred to an account associated with the contribution platform 112 (and the corresponding organization, etc.). Again, it should be appreciated that in some system embodiments, the contribution platform 112 may be omitted from the system 100.

The payment network 106 is coupled in communication with the issuer 102 and with the contribution platform 112 (when present), or other suitable financial or non-financial institutions (e.g., merchants, acquiring banks, etc.). The payment network 106 is configured, generally, to coordinate payment account transactions between financial institutions, including, for example, the issuer 102, etc. In this example embodiment, the payment network 106 includes an image platform 114 and a digital service 116. The image platform 114 is configured to store and provide digital images associated with accounts (e.g., for cards associated with the accounts, etc.). The digital service 116 is configured to act as a backend for one or more digital wallet applications, including, for example, a digital wallet application 118 included in the device 110, etc. In connection therewith, in particular, the digital service 116 is configured to provide a token associated with an account to the wallet application 118, whereby the account is provisioned to the application 118 (and for any other accounts desired to be provisioned to the application 118), and to further coordinate messaging associated with the provisioned account (e.g., with the device 110, the issuer 102, etc.). What's more, the digital service 116 may be configured as a wallet platform for the digital wallet application 118, included in the device 110, or may be configured to interface with a wallet platform (not shown) on behalf of the issuer 102 and/or the user 104, etc.

The device 110 is associated with the user 104 and may include any suitable electronic communication device, including, for example, a mobile phone (e.g., a smartphone, etc.), a wearable device (e.g., a watch such as an Apple Watch™; a Garmin™ device; or a FitBit™ device; etc.), a tablet, etc. In general, the device 110 is carried with the user 104, as the user moves from place to place. (e.g., whereby the device 110 is present with the user 104 at a merchant, etc.). What's more, the digital wallet application 118 may be associated with the payment network 106 or the issuer 102, and may be provisioned, at the device 110, with accounts issued by the issuer 102 and other issuers (e.g., as generally described above, etc.), etc.

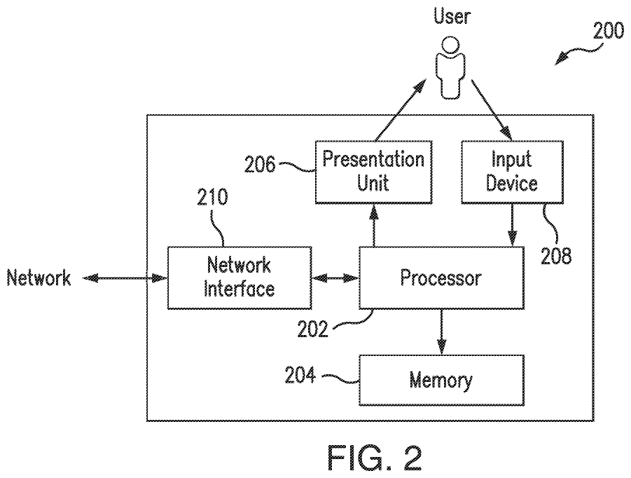

FIG. 2 illustrates example computing device 200 used in the system 100. The computing device 200 may include, for example, one or more servers, workstations, personal computers, laptops, tablets, smartphones, wearable devices, PDAs, etc. In addition, the computing device 200 may include a single computing device, or it may include multiple computing devices located in close proximity or distributed over a geographic region, so long as the computing devices are configured to function as described herein. In the system 100, the issuer 102, the contribution platform 112 (when present), and the payment network 106 are each illustrated as including computing device 200, coupled to the network 108. In addition, the device 110 is a computing device coupled to the network 108, where the device 110 may be consistent with computing device 200. That said, the system 100 (and the parts thereof) should not be considered to be limited to the computing device 200, as described below, as different computing devices and/or arrangements of computing devices may be used. In addition, different components and/or arrangements of components may be used in other computing devices in other embodiments.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the operations described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, tokens, identifiers, card images, badges, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein, whereby such performance may transform the computing device 200 into a special-purpose computing device. It should be appreciated that the memory 204 may include a variety of different memories, each implemented in connection with one or more of the functions or processes described herein.

In the example embodiment, the computing device 200 also includes a presentation unit 206 that is coupled to (and that is in communication with) the processor 202 (however, it should be appreciated that the computing device 200 could include output devices other than the presentation unit 206, etc.). The presentation unit 206 outputs information (e.g., card images with or without badges, dynamic card images, specialize card images, etc.), visually, for example, to a user of the computing device 200 such as, for example, the user 104 of the device 110, etc. Various interfaces (e.g., as defined by network-based applications, etc.) may be displayed at computing device 200, and in particular at presentation unit 206, to display and/or solicit certain information, as described herein, for example, and displayed at the presentation unit 206. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

In addition, the computing device 200 includes an input device 208 that receives inputs from the user (i.e., user inputs) such as, for example, credentials associated with the user 104, or selections by the user 104, etc. The input device 208 is coupled to (and is in communication with) the processor 202 and may include, for example, one or more of a keyboard, a pointing device, a mouse, a camera, a touch sensitive panel (e.g., a touch pad or a touch screen, etc.), and/or other suitable input device. Further, in various example embodiments, a touch screen may behave as both the presentation unit 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., a Wi-Fi adapter, a Bluetooth® adapter, etc.), a mobile network adapter, or other device capable of communicating to one or more different networks, including the network 108. In some example embodiments, the computing device 200 may include the processor 202 and one or more network interfaces (including the network interface 210) incorporated into or with the processor 202.

Referring again to FIG. 1, at the outset, the payment network 106 is configured to interact with the issuer 102 to onboard the issuer 102, and by extension, each account issued by the issuer 102 (e.g., or at least accounts associated with the functionality described herein, etc.). In particular, the onboard includes the permissions for the payment network 106 to interact with the user 104 (and other users), as described herein, for example, with regard to the user's account(s) (as issued by the issuer 102), and/or to provide and/or update digital card images associated with the user's account(s) for use in the user's digital wallet (e.g., entire images, or badges appended in images, etc.), etc. In general, based on the onboarding, the payment network 106 is configured to compile and store a profile for the issuer 102 and/or the user 104, where the profile includes (for each of the user's accounts) a primary account number (PAN) for the account and a token associated with the account and provisioned to the digital wallet application 118 (as desired), etc.

In one aspect of the system 100 (also see, for example, method 300, etc.), the user 104 requests to register for a badge associated with the contribution platform 112, whereby the badge (or other image or theme (e.g., seasonal, holiday, etc.)) is to be appended to a digital card image for an account provisioned to the device 110 (and the application 118). The request may be in the form of a contribution (e.g., a transaction, etc.), or a request to register with the contribution platform 112, etc. The request then includes, for example, the PAN for the account (or funding PAN (FPAN)) (or the token provisioned to the application 118) and other suitable data about the user 104 and/or the account, etc.

The contribution platform 112, in response to the request (or upon completion of a transaction), is configured to identify the account, by the PAN/FPAN or token, to the payment network 106, as an account requesting a badge associated with the contribution platform 112. The contribution platform 112 may further be configured to identify itself (e.g., by an identifier, etc.) or the specific badge that is either requested by the user 104 or available to the user 104. In turn, the payment network 106 is configured to notify the issuer 102 of the request and to request an updated digital card image for the account. The request by the payment network 106 may include an identifier associated with the contribution platform 112 and/or a specific badge associated with the contribution platform 112 and/or requested by the user 104, etc.

In response, the issuer 102 is configured to compile configuration data for the user's account, which includes a base digital image of the card (e.g., a generic image associated with the card, etc.), a digital image for the badge, and an asset name. In connection therewith, the asset name may include a name and/or identifier for the given image (e.g., for the image of the badge and/or the combined image of the card and badge, etc.) (e.g., a name and/or identifier having up to thirty characters, etc.). The issuer 102 is configured to provide the configuration data to the payment network 106, via an application programing interface (API) or otherwise, whereby the payment network stores the data (e.g., stores the image of the badge and/or the combined image of the card and badge in association with the asset name, etc.).

The payment network 106 is configured to then load the digital image of the card and badge and the digital base image for the card into a data structure in the payment network 106 (i.e., for later recall) and to compile a revised or new configuration file for the account, and specific to the user 104. The revised or new configuration file includes generally the same configuration data as received from the issuer 102, and further includes the digital image of the card and badge (and/or data representative thereof). The payment network 106 is configured to transmit an identifier (ID) associated with the revised configuration file to the issuer 102. The issuer 102, in turn, is configured to store the ID for the revised configuration file in memory (e.g., the memory 204, etc.) (e.g., in association with the configuration data for the user 104 and/or the user's account, etc.).

Next, the issuer 102 is configured to provide the ID for the revised configuration file back to the payment network 106, along with a token associated with the user's account. The payment network 106 is configured to then link the ID for the revised configuration file to the token and to confirm the linking to the issuer 102. The payment network 106 is configured to then push a notice to the wallet application 118 (or to a backend of the application 118). In response, the device 110, as configured by the application 118, retrieves the digital image of the badge and the digital base image of the card, associated with the account, from the payment network 106 (or, alternatively, the digital image of the card and badge already incorporated together). In turn, when the user next accesses the wallet application 118, and specifically, the account included therein, the device 110, as configured by the application 118, displays the digital image of the card, along with the digital image of the badge incorporated therein or thereon.

It should be appreciated that, in this aspect of the system 100, the badge may be changed over time based on various purchases, or requests, or contributions, etc. and may be replaced or removed accordingly. In at least one embodiment, the payment network 106 and/or the issuer 102 is configured to operate, as described above, to remove the digital image of the badge from the digital image of the card (i.e., via a revised configuration file without the badge) after a period of time, or based on other criteria.

In another aspect of the system 100 (also see, for example, method 500, etc.), the user 104 may view and select a new digital card image for an account. In connection therewith, the image platform 114 is configured to provide access to the user 104, via the device 110, to view and select different digital card images stored therein (in the image platform 114). When the user 104 selects a new digital card image, the user 104 also provides a PAN/FPAN to the image platform 114 for the corresponding account. The image platform 114 is configured to them provide the PAN/FPAN and the digital image to the digital service 116.

In response, the digital service 116 is configured to identify the token for the account based on the FPAN, and then to update a configuration file associated with the token (and the associated account).

The digital service 116 is configured to then push a notice to the wallet application 118 (or to a backend of the application 118). In turn (or in response to the notice), the device 110, as configured by the application 118, retrieves the newly selected digital image for the card, associated with the account, from the payment network 106. When the user 104 next accesses the application 118, and specifically, the account, the device 110, as configured by the wallet application 118, displays the selected digital image of the card.

In addition, the digital service 116 is configured to transmit a notice of the change in the digital image of the card associated with the account to the issuer 102, whereby the issuer 102 may append the change to (or associate the change with) the configuration data for the user 104 and/or the user's account.

It should be appreciated that the payment network 106 may be configured, consistent with either of the above aspects (be it the particular example aspect involving the contribution platform 112 or the more general aspect in which the contribution platform 112 is not involved), to change the digital image for the card, or (in embodiments involving the contribution platform 112) the badges associated with the user's account, from time to time. For example, the digital images may be changed, consistent with the above, in response to expiration of an interval, or in response to a subsequent request (e.g., a transaction involving a different contribution platform, etc.). In such instances, the digital image may be generally altered as desired, or altered to include another badge or selected image, or may be altered to revert to a base digital image, alone.

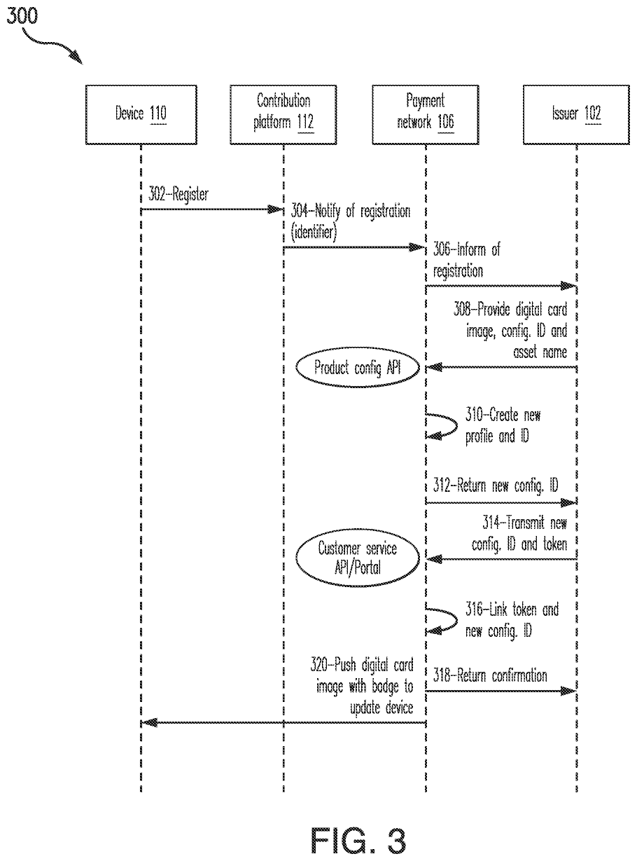

FIG. 3 illustrates an example method 300 for use in appending an added digital image (e.g., a digital image of a badge, etc.) to a base digital image of a card associated with an account. In connection therewith, the method 300 is generally described with regard to the issuer 102, the contribution platform 112 (e.g., with which the added digital image (e.g., the badge, etc.) is associated, etc.) and the payment network 106, and with reference to the computing device 200. It should be appreciated, however, that the methods herein are not limited to the system 100 and/or the computing device 200, and conversely that the systems and computing devices herein are not limited to method 300.

In the method 300, at the outset, it should be understood that the account of the user 104 is enrolled in a program associated with the payment network 106 (by which the payment network 106 has onboarded the issuer 102 and the account of the user 104). As such, the payment network 106 is aware of the account, and the potential of a request, which may trigger a change in the image of a digital card that is displayed to the user 104 at the device 110 when the account is used for a purchase.

In connection therewith, at 302, the user 104 registers with the contribution platform 112, via the device 110, whereby the contribution platform 112 is permitted to request a change in the digital card image through the payment network 106 (e.g., to include a badge associated with the contribution platform 112, etc.) (e.g., as part of a service provided by the payment network 106 for onboarded accounts, etc.). For instance, the user 104 and/or the contribution platform 112 may request inclusion of a particular badge or multiple badges associated with the contribution platform 112 with a digital image of a card of the user 104. In doing so, the user 104 is able to tailor the digital image of his/her card to include the badge(s) and thereby indicate his/her association with the contribution platform 112, etc. The registration may include a contribution (e.g., a donation, another transaction, etc.) to the contribution platform 112, whereby as part of the interaction the user 104 indicates a desire or permission of the digital card image to be altered. Regardless of the form of the registration, the contribution platform 112 receives an identifier associated with the user's account (e.g., PAN, FPAN, token, etc. from the device 110; etc.).

In response, at 304, the contribution platform 112 notifies the payment network 106 of the registration of the user 104. The notification includes, for example, the identifier of the user's account, an identifier associated with the contribution platform 112 (e.g., a program identifier, a reference number, etc.), and other suitable data associated with the user 104, the contribution platform 112 (e.g., a badge associated with the contribution platform 112, etc.) and/or the digital card image for the user's account, etc. In turn, the payment network 106 informs, at 306, the issuer 102 of the registration, whereby the issuer 102 is requested to update the digital card image for the account at the digital wallet application 118. The payment network 106 may also forward details of the request to the issuer 102 (e.g., the identifier of the user's account, the identifier associated with the contribution platform 112, the badge associated with the contribution platform 112, the digital card image for the user's account, etc.).

The issuer 102, in response, calls an API associated with the payment network 106 (e.g., a product configuration API, etc.), through which the issuer 102 provides, at 308, a digital card image including a base image of the card and the desired badge associated with the contribution platform 112, or otherwise, based on the request. In connection therewith, the digital card image may be retrieved, by the issuer 102, based on the identifier of the contribution platform 112, based on other content of the request, etc. In addition to the digital card image, the issuer 102 provides, via the API, a base or existing configuration ID for the account, and an asset name for the image including the desired badge. While the data described above is provided to the payment network 106, via the API in this embodiment, it should be appreciated that the issuer 102 may provide the data associated with updating the digital card image in any other suitable manner.

Upon receipt of the data from the issuer 102, the payment network 106 stores the digital card image in memory (e.g., in a repository of card images, etc.), in association with the asset name, and creates, at 310, a new configuration profile and ID for the account. In particular, the payment network 106 retrieves a base configuration profile for the account, based on the base configuration ID from the issuer 102, and then clones or copies the base configuration profile, but modifies the configuration ID (i.e., to make the new configuration ID unique from the existing configuration ID) and also attaches the new digital card image to the new configuration profile, thereby creating the new configuration profile. At 312, the payment network 106 returns the new configuration ID to the issuer 102, who stores the new configuration ID in connection with the account.

It should be appreciated that in this embodiment, the new and base configuration profiles are maintained, whereby the base or any prior configuration profile may be recalled by the configuration ID specific to the profile rather than creating new profiles for each alteration. That said, it should be appreciated that the existing configuration profile may be overwritten in other method embodiments, as desired.

With continued reference to FIG. 3, the issuer 102 transmits, at 314, the new configuration ID along with the existing token for the account, in the digital wallet, to the digital wallet application 118 in the device 110. Consistent with the above, the issuer 102 may provide the new configuration ID to the payment network 106, via an API (e.g., a customer service API, etc.) or otherwise (e.g., a customer service portal, etc.).

The payment network 106 then links, at 316, the token to the new configuration ID (e.g., with the new configuration file generated by the payment network 106, etc.), thereby overwriting the base configuration ID for the token, whereby the token is linked to the new configuration ID profile and the digital card image therein. The payment network further returns, at 318, a confirmation of the link between the token and the new configuration ID to the issuer 102. And, finally, the payment network 106 pushes, at 320, the new configuration ID profile, including at least the digital card image with the badge, to the device 110. In response the device 110, and specifically, the digital wallet application 118, updates the digital card image for the account (and the token) therein based on the new configuration ID profile. Consequently, when the user 104 selects the account for a future purchase, the device 110 displays the digital card image with the badge to the user 104, and the merchant or other third party to which the user 104 presents the account for payment.

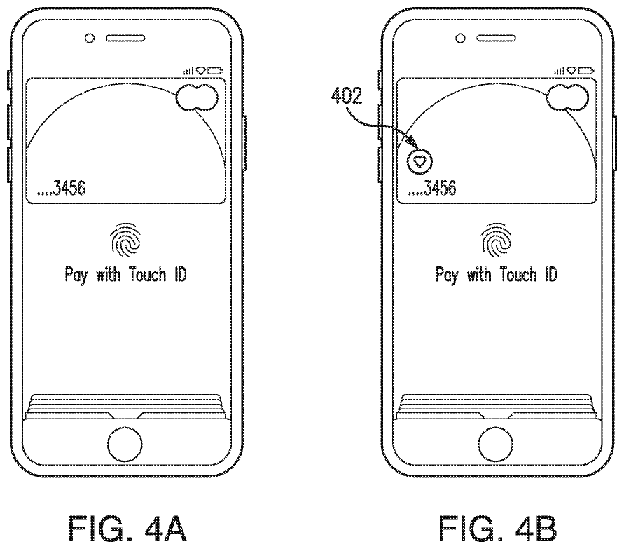

FIG. 4A illustrates an example interface that may be displayed via the digital wallet application 118, at the device 110, in which a base image of a digital card is displayed. And FIG. 4B, then, illustrates the example interface with a new image of the digital card displayed including a badge 402 (e.g., described in the method 300, etc.). As such, the base image of the digital card is preserved, in this example embodiment, and the badge 402 is appended to the bottom left corner of the base image, thereby providing the new image of the digital card (as a combination of the base image and the badge 402). It should be appreciated that the badge, or another appendage to the base image having the same or different dimensions, colors, shapes, etc., may be used in other embodiments.

That said, it should be appreciated that the image of the digital card may be changed again by another contribution platform in subsequent transactions/requests, etc., through steps consistent with those described above in the method 300. What's more, it should be appreciated that the issuer 102, after an interval, may cause the card image to revert to the base image of the digital card (without the badge 402) by providing the base configuration ID to the payment network 106 along with the token, for example, at 314 in the method 300, thereby causing the payment network 106 to update the image of the digital cared with the base image (i.e., as associated with the base configuration ID profile for the account), for example, consistent with steps 316-320 in the method 300 described above.

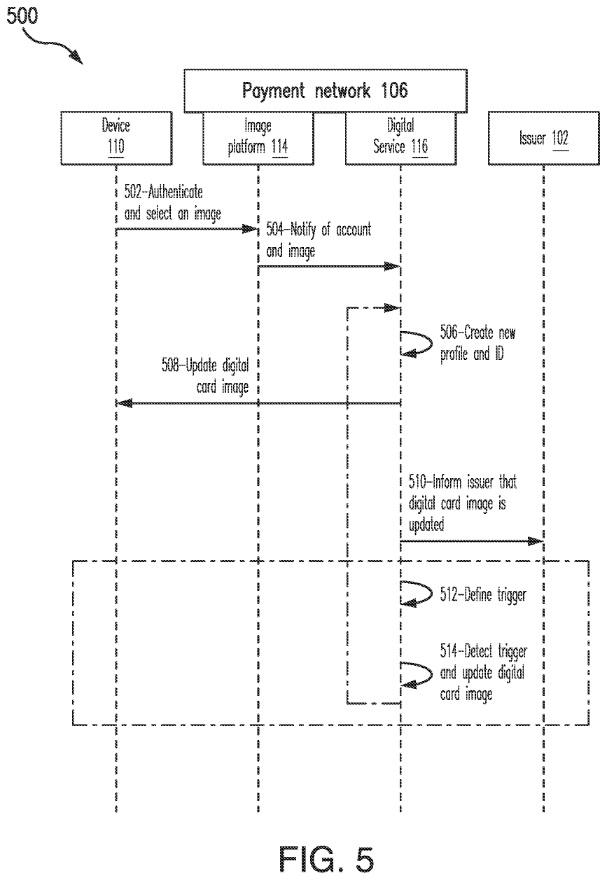

FIG. 5 illustrates another example method 500 for altering an image of a digital card associated with an account. In connection therewith, the method 500 is generally described with regard to the issuer 102 and the payment network 106 (including the image platform 114 and the digital service 116), and with reference to the computing device 200. It should be appreciated, however, that the methods herein are not limited to the system 100 and/or the computing device 200, and conversely that the systems and computing devices herein are not limited to method 500.

In the method 500, at the outset again, it should be understood that the account of the user 104 is enrolled in a program associated with the payment network 106 (through which the payment network 106 has onboarded the issuer 102 and the account of the user 104). As such, the payment network 106 is aware of the user's account, and the potential for a request that may trigger a change in the image of a digital card that is displayed to the user 104 at the device 110 when the account is used for a purchase.

At 502, the user 104 accesses the digital wallet application 118, at the device 110, and is authenticated (e.g., via biometric, passcode, personal identification number (PIN), password, etc.). Once authenticated, in this example, the user 104 is permitted to either upload an image or to browse available images for a digital card associated with his/her account (e.g., from the image platform 114, via the digital wallet application 118, etc.). The user 104 may be permitted to browse through images provided from the image platform 114, prior to selecting an image, etc. In connection therewith, the user 104, via the device 110, selects an image to include with (or as) the image of the digital card (or part thereof) for the user's account (in the application 118 at the device 110). The selection is accompanied, in this example, by the user's account identifier (e.g., PAN, FPAN, token (or device PAN or DPAN), etc.).

The image platform 114 then notifies, at 504, the digital service 116 of the selection of the image for the account. The notification includes, for example, the identifier of the account (e.g., PAN, FPAN, DPAN, token, etc.) (for example, thereby permitting the digital service 116 to identify the account holder and/or identify the image to the specific account) and the selected image (or an identifier of the selected image).

In response, the digital service 116 creates, at 506, a new configuration profile and ID for the account. In particular, in this example embodiment, the payment network 106 (or more specifically, the digital service 116) retrieves a base configuration profile for the account and then clones or copies the base configuration profile, but modifies the configuration ID (i.e., to make the new configuration ID unique from the existing configuration ID) and also attaches the selected image to the new configuration profile, thereby creating the new configuration profile. The selected image may include the base image of the digital cared for the account plus the selected image (e.g., where the selected image is meant to be overlaid on the base image of the digital card, etc.), or potentially, the selected image may replace the base image of the digital card.

The digital service 116 then updates, at 508, the image of the digital card at the device 110. In particular, the digital service 116 pushes the new configuration ID profile, including at least the digital card's image with the badge, to the device 110. In response, the device 110, and specifically, the digital wallet application 118, updates the digital card image for the account (and the token) therein. Consequently, when the user 104 selects the account for a future purchase, the device 110 displays at least the selected image of the digital card to the user 104, and the merchant or other third party to which the user 104 presents the account for payment.

Then, at 510, the payment network 106 (or, in this example, digital service 116) informs the issuer 102 that the card image for the digital card of the user's account is updated.

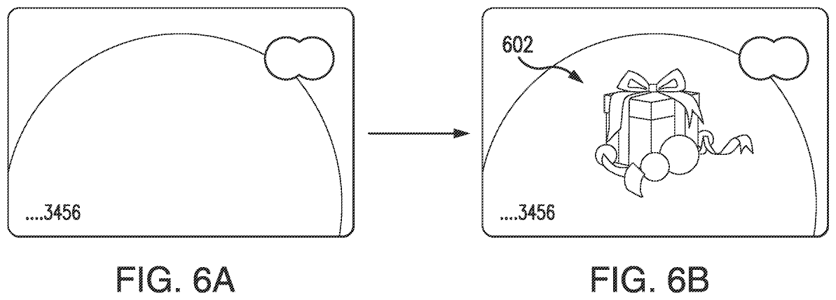

FIG. 6A illustrates an example interface that may be displayed via the digital wallet application 118, at the device 110, in which a base image of a digital card is displayed. And, FIG. 6B then illustrates the example interface with a selected image 602 overlaid on the base image of the digital card (and the combination thereof displayed). As such, the base image of the digital card is preserved, in this example embodiment, and the selected image 602 is appended to thereto, thereby providing the new image for the digital card. It should be appreciated that the selected image, or another appendage to the base image of the digital card having the same or different dimensions, colors, shapes, etc., may be used in other embodiments.

Referring again to FIG. 5, optionally, as indicated by the dotted box, the payment network 106 and/or the digital service 116 may define, at 512, one or more triggers for an update or change to the image of the user's digital card at the device 110. For example, one or more rules may define which image is displayed to the user 104 at the device 110 at what times. An example of such a rule may include automatically updating digital images of cards associated with specific tokens on December 25 to include a particular holiday image. Another example of such a rule may include automatically updating digital images of cards associated with users when the users reach a particular spend level for a month, quarter, year, etc.

Consequently, then, in this optional scenario, the payment network 106 and/or digital service 116 detects, at 514, when the card image update trigger occurs, and then proceeds to update the image of the digital card. In the illustrated method 500, the payment network 106 and/or digital service 116 returns then to step 506, whereby the new configuration profile for the account, based on the rules for the trigger, is defined. As above, the change in the image of the user's digital card, based on the trigger, proceeds to the device 110, where the image of the digital card is, in fact, changed.

In view of the above, the systems and methods herein permit dynamic images to be associated with user accounts (e.g., generally automatically, etc.), whereby the dynamic images are presented at or through digital cards associated with the accounts. For instance, the systems and methods herein may allow for updating, modifying, etc. images of digital cards, associated with accounts, to include additional details, data, images, etc. particular to the users and/or the accounts associated therewith. What's more, the dynamic images may be provided by the payment network as an on-behalf service to the issuers of the given accounts, whereby the payment network may update the issuers' provided digital card art with specific images (e.g., as selected by the users, as selected based on specific triggers, etc.), and without dependency on the issuers (and/or the issuers' underlying card art). In this way, the systems and methods herein may allow for tailoring and/or customizing and/or personalizing the images of the digital cards to the users and/or the users' accounts (e.g., whereby the personalized art for the digital cards may be pushed by the payment network to the users' digital wallets for use, etc.), and/or to differentiate the digital cards from those of other issuers and/or payment networks. The tailoring and/or customizing and/or personalizing of the images associated with the digital cards may further be tied to specific transactions (e.g., donations, contributions, etc.), whereby the dynamic images may be specific to those transactions. In this manner, the users are able to portray interests, values, charity, hobbies, or other context for the users in connection with the presentment of the digital cards, etc.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transforms a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by a method, a system, or a computer-readable medium providing: (a) receiving, by a computing device, a request for an image associated with an account; (b) informing, by the computing device, an issuer of the account of the request; (c) receiving, by the computing device, from the issuer, an image and a base configuration ID for the account; (d) retrieving, by the computing device, a base configuration profile for the account, based on the base configuration ID; (e) creating, by the computing device, a new configuration profile for the account, based on the retrieved base configuration profile, the new configuration profile including the image received from the issuer and a new configuration ID; (f) returning, by the computing device, to the issuer, the new configuration ID; (g) receiving, by the computing device, from the issuer, in response to the new configuration ID, a token for the account; (h) linking, by the computing device, the token to the new configuration profile based on the new configuration ID; and (i) pushing, by the computing device, the image to a digital wallet of a device associated with the account, thereby permitting the device to display the image, as compared to a prior image, when the account is selected at the digital wallet of the device.

As will also be appreciated based on the foregoing specification, the above-described embodiments of the disclosure may be implemented using computer programming or engineering techniques including computer software, firmware, hardware or any combination or subset thereof, wherein the technical effect may be achieved by a method, a system, or a computer-readable medium providing: (a) receiving, by a computing device, a request to associate a selected image with an account at a digital wallet at a device; (b) creating, by the computing device, a new configuration profile for the account, based on the received image, the new configuration profile including the image and a new configuration ID; (c) pushing, by the computing device, the image to a device associated with the account, thereby permitting the digital wallet at the device to display the selected image, as compared to a prior image, when the account is selected at the digital wallet at the device; and (d) informing, by the computing device, the issuer of the selected image.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

In addition, as used herein, the term product may include a good and/or a service.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for altering an image associated with an account, for use in connection with a digital wallet, the method comprising:
receiving, by a computing device, a request for an image associated with an account;
informing, by the computing device, an issuer of the account of the request;
receiving, by the computing device, from the issuer, the image and a base configuration ID for the account;
retrieving, by the computing device, a base configuration profile for the account, based on the base configuration ID;
creating, by the computing device, a new configuration profile for the account, based on the retrieved base configuration profile, the new configuration profile including the image received from the issuer and a new configuration ID;
returning, by the computing device, to the issuer, the new configuration ID;
receiving, by the computing device, from the issuer, in response to the new configuration ID, a token for the account;
linking, by the computing device, the token to the new configuration profile based on the new configuration ID; and
pushing, by the computing device, the image to a digital wallet of an electronic device associated with the account, thereby permitting the electronic device to display the image, as compared to a prior image, when the account is selected at the digital wallet of the electronic device.

2. The computer-implemented method of claim 1, wherein the image includes a card image.

3. The computer-implemented method of claim 2, wherein the card image includes a base image of a card and an image of a badge overlaid on the image of the card.

4. The computer-implemented method of claim 3, wherein the request for the image is received from a contribution platform; and
wherein the badge is indicative of the contribution platform.

5. The computer-implemented method of claim 4, wherein the request includes a transaction between the account and the contribution platform.

6. The computer-implemented method of claim 1, further comprising, after pushing the image to the electronic device:
returning the base configuration ID associated with a base configuration profile to the issuer;
receiving, from the issuer, the token associated with the account;
linking the token to the base configuration profile; and
pushing, by the computing device, a base image included in the base configuration profile to the electronic device associated with the account.

7. The computer-implemented method of claim 6, further comprising notifying, by the computing device, the issuer of the image being pushed to the electronic device.

8. A computer-implemented method for altering an image associated with an account, for use in connection with a digital wallet, the method comprising:
receiving, by a computing device, a request to associate a selected image with an account at a digital wallet of an electronic device;
creating, by the computing device, a new configuration profile for the account, based on the received image, the new configuration profile including the image and a new configuration ID;
pushing, by the computing device, the image to the electronic device associated with the account, thereby permitting the digital wallet at the electronic device to display the selected image, as compared to a prior image, when the account is selected at the digital wallet at the electronic device; and
informing, by the computing device, the issuer of the selected image.

9. The computer-implemented method of claim 8, further comprising,
detecting a trigger condition; and
in response to detecting the trigger condition:
retrieving, by the computing device, from memory, a prior configuration profile for the account, the prior configuration profile including a base image; and
pushing, by the computing device, the base image to the electronic device associated with the account, thereby permitting the digital wallet at the electronic device to display the base image, as compared to the selected image, when the account is selected at the electronic device.

10. The computer-implemented method of claim 8, wherein the image includes a card image.

11. The computer-implemented method of claim 10, wherein the card image includes a base image of a card and an image of a badge overlaid on the image of the card.

12. The computer-implemented method of claim 11, wherein the request to associate the selected image with the account is received from a contribution platform; and
wherein the badge is indicative of the contribution platform.

13. The computer-implemented method of claim 12, wherein the request includes a transaction between the account and the contribution platform.

14. A system for altering an image associated with an account, for use in connection with a digital wallet, the system comprising:
at least one computing device configured to:
receive a request to associate a selected image with an account at a digital wallet of an electronic device;
create a new configuration profile for the account, based on the received image, the new configuration profile including the image and a new configuration ID;
push the image to the electronic device associated with the account, thereby permitting the digital wallet at the electronic device to display the selected image, as compared to a prior image, when the account is selected at the digital wallet at the electronic device; and
inform the issuer of the selected image.

15. The system of claim 14, wherein the image includes a card image.

16. The system of claim 15, wherein the card image includes a base image of a card and an image of a badge overlaid on the image of the card.

17. The system of claim 14, wherein the request includes a transaction between the account and the contribution platform.

18. The system of claim 14, wherein the request to associate the selected image with the account is received from a contribution platform; and
wherein the badge is indicative of the contribution platform.

19. The system of claim 14, wherein the at least one computing device is further configured to:
detect a trigger condition; and
in response to the trigger condition:
retrieve, from memory, a prior configuration profile for the account, the prior configuration profile including a base image; and
push the base image to the electronic device associated with the account, thereby permitting the digital wallet at the electronic device to display the base image, as compared to the selected image, when the account is selected at the electronic device.
